(19) United States
(12) Patent Application Publication
(10) Pub. No.: US 2026/0273630 A1
(43) Pub. Date: Sep. 17, 2026

(54) CUTTING TOOL

(71) Applicant: SECO TOOLS AB, Fagersta (SE)

(72) Inventors: Sudarshan PATIL, Fagersta (SE); Manoj TATHE, Fagersta (SE); Mikael LINDHOLM, Fagersta (SE); Jimmy THELIN, Fagersta (SE)

(21) Appl. No.: 18/871,977

(22) PCT Filed: Jan. 26, 2023
(86) PCT No.: PCT/EP2023/051890

§ 371 Date: Dec. 5, 2024

(30) Foreign Application Priority Data
Jun. 28, 2022 (EP) 22181414.8

(51) Int. Cl. B23B 27/16

(52) U.S. Cl. CPC B23B 27/1614; B23B 2200/087; B23B 2200/204; B23B 2205/12

(57) ABSTRACT

A cutting tool includes a toolholder having a toolholder body, at least one insert pocket, and a cutting insert being mounted within the at least one insert pocket. The cutting insert has a first main surface, a second main surface, and a peripheral side surface connecting the first main surface and the second main surface. The cutting insert includes a central plane extending midway between the first main surface and the second main surface. The cutting insert has at least one insert support element, wherein the insert support element is either an indention extending from the second main surface towards the central plane or a protrusion extending from the second main surface away from the central plane. The insert pocket includes a pocket support element being either a protrusion engaging with the indention in the second main surface or an indention engaging with the protrusion at the second main surface.

### TECHNICAL FIELD

The present invention relates to a cutting tool.

### BACKGROUND

Within the cutting industry it is common to use a cutting tool comprising a toolholder with at least one replaceable cutting insert, having at least one cutting edge, mounted therein for performing a cutting process. It is common to use indexable cutting inserts having a plurality of cutting edges, wherein the cutting insert can be rotated in order to index a new cutting edge as the active cutting edge used in the cutting process. Cutting inserts having an overall square shape are commonly used in rough machining processes, such as rough turning. Due to the rough conditions generated when performing these types of machining, there may become damages on the cutting insert adjacent to the cutting edge due to the contacts between the cutting insert and the chips generated during machining. As a result of this, a common solution is to use a cutting tool having an overall square shaped cutting insert arranged therein. The cutting insert has two cutting edges separated from each other in such a way that the non-active cutting edge is protected from the chips generated during machining when mounted in the toolholder. Such a cutting tool is disclosed in EP 3 006 141 B1.

A problem with this type of cutting tool is that, since the cutting insert has an overall square shape, there is a risk that the operator erroneously indexing a non-cutting part of the cutting insert as the active cutting edge, which will have a significant impact on the stability of the cutting tool, and thereby on the quality of the performed cutting process.

Attempts to overcome this problem have been made by providing cutting inserts with orientation-assisting clamping recesses. Such solutions are disclosed in e.g. US 2019/160556 A1 and KR 101 471 252 B1. Even if such a solution to some extent provides a solution to the problem, the result has not proven to be sufficient.

### SUMMARY OF THE INVENTION

It is an object of the present invention to overcome, or at least partially overcome, said problem by introducing a cutting tool.

The object of the present invention is achieved by means of a cutting tool comprising:
a toolholder comprising a toolholder body and at least one insert pocket; and
at least one cutting insert, wherein
   the at least one cutting insert is mounted within the at least one insert pocket, wherein said at least one cutting insert comprises:
a first square shaped main surface;
a second square shaped main surface; and
a peripheral side surface connecting the first main surface and the second main surface, wherein
   the at least one cutting insert comprises a central plane P₁ extending midway between the first main surface and the second main surface, and wherein the at least one cutting insert comprises a central axis A extending between the first main surface and the second main surface perpendicular to the central plane P₁, wherein the at least one cutting insert comprises at least one insert support element, wherein the insert support element being any of:
an indention extending from the second main surface towards the central plane P₁; or
a protrusion extending from the second main surface away from the central plane P₁, wherein
   the second main surface has an exactly two-fold rotational symmetry around the central axis A, and wherein the first main surface has an exactly two-fold rotational symmetry around the central axis A, wherein the at least one cutting insert comprises a first cutting edge at a first intersection between the first main surface and the peripheral side surface, and a second cutting edge at a second intersection between the first main surface and the peripheral side surface, wherein the first cutting edge and the second cutting edge are separated from each other, wherein
   the insert pocket comprises a bottom support surface and at least one side support surface, wherein the bottom support surface is in contact with the second main surface, and wherein the at least one side support surface is in contact with the peripheral side surface, wherein
   the insert pocket comprises at least one pocket support element, wherein the pocket support element being any of:
a protrusion engaging with the indention in the second main surface, or
an indention engaging with the protrusion at the second main surface, wherein
   the insert support element comprises an insert support surface, and wherein the pocket support element comprises a pocket support surface, wherein the insert support surface is in contact with the pocket support surface, wherein the insert support surface contacts the pocket support surface in a plurality of contact regions, wherein each contact region is separated from the other contact regions.

Having the contact regions separated from each other means that they do not contact each other.

By arranging a pocket support element in the bottom support surface which is configured to engage with the insert support element in the second main surface, the risk of incorrectly mounting the cutting insert in the insert pocket is reduced since the protrusion, in either the insert pocket or at the cutting insert, will prevent a stable mounting of the cutting insert if not mounted correctly, which would be a clear indication to the operator that an incorrect mounting has been made. By having both the first and second major surfaces having an exactly two-fold rotational symmetry around the central axis A, it is ensured that a cutting edge is correctly provided when the insert support element and the pocket support element engage with each other.

By having the insert support surface and the pocket support surface arranged in contact with each other in a plurality of contact regions as described above, the stability in the mounting of the cutting insert in the insert pocket is improved since the contact between the insert support element and the pocket support element can be directed towards the areas of the cutting insert where the generated cutting forces becomes the highest. Having a stable mounting of the cutting insert in the insert pocket reduces the amount of vibrations in the cutting tool, which improves the cutting process.

The cutting tool is preferably a metal cutting tool.

According to an embodiment, the cutting tool is a turning tool. The turning tool is preferably configured for use in a rough turning operation.

According to an embodiment, the cutting insert is a cubic boron nitride (CBN) cutting insert, a cemented carbide cutting insert, a cermet cutting insert, or a ceramic cutting insert.

The first and second main surfaces being square shaped means that they have the shape of a square with either sharp or rounded corners. According to some embodiments, the corners are truncated. According to some embodiments, the sides of the square can be slightly inclined towards the central axis A.

According to an embodiment, the first main surface comprises a first chip breaker and a second chip breaker, wherein the first chip breaker is arranged adjacent to the first cutting edge and the second chip breaker is arranged adjacent to the second cutting edge.

By arranging a first chip breaker adjacent to the first cutting edge and a second chip breaker adjacent to the second cutting edge, the chip formation in the cutting tool is improved resulting in an improved cutting process.

According to an embodiment, the first main surface comprises four corners and wherein the first cutting edge and the second cutting edge are located at diagonally opposing corners of the first main surface.

By arranging the first and second cutting edges at diagonally opposing corners of the first main surface, the cutting tool become particularly suitable for use in a rough turning operation since the second cutting edge will be protected from the chips generated when the first cutting edge is cutting the workpiece due to its location in the insert pocket.

According to an embodiment, the at least one insert support element has a major axis B and a minor axis C being perpendicular to each other and to the central axis A, wherein the at least one insert support element has a length l₁ in the direction of the major axis B and a length l₂ in the direction of the minor axis C, wherein l₁>l₂.

By arranging the at least one insert support element as described above where l₁>l₂, a stable mounting of the cutting insert in the insert pocket is achieved since the insert support element can be arranged so that the most support is provided beneath the cutting edges where the generated cutting forces becomes the highest. Having a stable mounting of the cutting insert in the insert pocket reduces the amount of vibrations in the cutting tool, which improves the cutting process.

According to an embodiment, a bisector D bisects the first cutting edge and the second cutting edge, wherein the bisector D is parallel to the major axis B.

By arranging the bisector D parallel to the major axis B, a stable mounting of the cutting insert in the insert pocket is achieved since the insert support element becomes arranged so that the most support is provided beneath the cutting edges where the generated cutting forces becomes the highest.

According to an embodiment, the length l₂ diverges along the direction of the major axis B, wherein l₂ has its maximum at the position l₁/2 along the major axis B.

By having the maximum of l₂ located at the position l₁/2 along the major axis B, the mounting of the cutting insert in the pocket becomes even more stable since the contact between the insert support element and the pocket support element also provides support to the areas of the cutting insert adjacent to the cutting edges, which are also exposed to generated cutting forces, even if to a less extent than at the cutting edge.

According to an embodiment, the second main surface comprises four corners and wherein the distance between two diagonally opposing corners is l₃, wherein l₁/l₃≥0.8.

By having the ratio between l₁ and l₃ being at least 0.8, the mounting of the cutting insert in the insert pocket becomes even more stable since the contact area between the insert support element and the pocket support element is increased.

According to an embodiment, the at least one cutting insert comprises a through hole extending from the first main surface to the second main surface in the direction of the central axis A, wherein the through hole intersects the insert support element, and wherein the through hole has a diameter d, wherein the maximum value of l₂ is larger than d.

By having the maximum value of l₂ being longer than d, the mounting of the insert in the insert pocket becomes even more stable since the contact areas between the insert support element and the pocket support element extends in several directions around the through hole.

According to an embodiment, the insert support surface and the pocket support surface are parallel to the central plane P₁.

By arranging both the insert support surface and the pocket support surface parallel to the central plane P₁, the mounting of the cutting insert in the insert pocket becomes even more stable due to an increased contact area between the insert support element and the pocket insert element.

According to an embodiment, the insert support surface contacts the pocket support surface in at least four contact regions.

By having the insert support surface and the pocket support surface arranged in contact with each other in at least four contact regions as described above, the mounting of the cutting insert in the insert pocket becomes even more stable since the contact between the insert support element and the pocket support element also provides support to the areas of the cutting insert adjacent to the cutting edges, which are also exposed to generated cutting forces, even if to a less extent than at the cutting edge.

According to an embodiment, the at least four contact regions comprise at least two major contact regions and at least two minor contact regions, wherein each major contact region has a surface area A₁ and each minor contact region has a surface area A₂, wherein A₁>A₂.

By arranging the contact regions as two major contact regions and two minor contact regions, it is possible to differentiate the amount of support between the cutting insert and the insert pocket across the contact area depending on how much support that is needed due to the generated cutting forces. Thereby, a higher amount of support can be provided beneath the cutting edges where the generated cutting forces becomes the highest when the cutting tool is used in the cutting process.

According to an embodiment, the major contact regions and the minor contact regions are alternately arranged in a circumferential direction around the central axis A.

By having the major contact regions and the minor contact regions alternately arranged in a circumferential direction around the central axis A, it is possible to provide the largest contact area between the insert support element and the pocket insert element beneath the cutting edge where the generated cutting forces becomes as highest when the cutting tool is used in the cutting process. Thereby, a more stable mounting of the cutting insert in the insert pocket is achieved.

According to an embodiment, a bisector E bisects the two major contact regions and wherein a bisector F bisects the two minor contact regions, wherein the bisector E is perpendicular to the bisector F.

By having the bisectors E and F arranged perpendicular to each other, an evenly distribution of the contact regions between the cutting insert and the insert pocket is achieved, which results in an even more stable mounting of the cutting insert in the insert pocket.

According to an embodiment, the bisector E is parallel to the bisector D.

By having the bisector E arranged perpendicular to the bisector D, the major contact regions will be provided beneath the cutting edges where the generated cutting forces becomes the highest when the cutting tool is used in the cutting process. Thereby, a more stable mounting of the cutting insert in the insert pocket is achieved.

According to an embodiment, the at least one cutting insert is a double sided cutting insert, wherein the central plane P₁ comprises a central axis G extending perpendicular to the central axis A, wherein the at least one cutting insert has a symmetry defined by a rotation of 180° around the central axis G plus a 90° rotation around the central axis A.

By arranging the at least one cutting insert as a double sided cutting insert as described above, the number of available cutting edges at the cutting insert will be doubled, resulting in an improved lifetime of the cutting insert.

According to an embodiment, the insert pocket comprises a removable shim arranged between the toolholder body and the cutting insert, wherein the shim comprises a top surface and a bottom surface, and a shim peripheral side surface connecting the top surface and the bottom surface, wherein the shim comprises a central plane P₂ extending midway between the top surface and the bottom surface, wherein the shim comprises a central axis H extending between the top surface and the bottom surface perpendicular to the central plane P₂, wherein the central axis H is arranged coaxially with the central axis A, wherein the top surface constitutes the bottom support surface, and wherein the pocket support element is arranged in the top surface.

By arranging a removable shim in the insert pocket between the toolholder body and the cutting insert, where the pocket support element is arranged in the removable shim, the need of a specially designed toolholder body is eliminated since the shim and the cutting insert can be arranged in a standard toolholder without any pocket support element.

According to an embodiment, the bottom surface comprises at least one shim support element, wherein the shim support element is any of:
an indention extending from the bottom surface towards the central plane P₂; or
a protrusion extending from the bottom surface away from the central plane P₂, and wherein
   the toolholder body comprises at least one body support element being any of:
a protrusion engaging with the indention in the bottom surface; or
an indention engaging with the protrusion at the bottom surface.

By arranging a shim support element in the bottom surface of the removable shim, and a body support element in the toolholder body, where the shim support element and the body support element engage each other, the risk of incorrectly mounting the shim in the toolholder body is reduced since the protrusion, in either the toolholder body or at the shim, would prevent a stable mounting of the shim if not mounted correctly, which would be a clear indication to the operator that an incorrect mounting has been made.

### BRIEF DESCRIPTION OF THE DRAWINGS

FIG. 1 schematically illustrates a cutting tool according to an embodiment of the invention.

FIG. 2 schematically illustrates a toolholder being part of the cutting tool illustrated in FIG. 1.

FIG. 3a schematically illustrates a perspective view of a cutting insert being part of the cutting tool illustrates in FIG. 1.

FIG. 3b schematically illustrates a side view of the cutting insert illustrated in FIG. 3a.

FIG. 3c schematically illustrates a top view of the cutting insert illustrated in FIG. 3a.

FIG. 3d schematically illustrates a bottom view of the cutting insert illustrated in FIG. 3a.

FIG. 4a schematically illustrates a perspective view of a removable shim being part of the toolholder illustrated in FIG. 2.

FIG. 4b schematically illustrates a side view of the removable shim illustrated in FIG. 4a.

FIG. 4c schematically illustrates a top view of the removable shim illustrated in FIG. 4a.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that the disclosure will be thorough and complete, and will fully convey the scope of the invention to those skilled in the art. Like reference numbers refer to like elements throughout. The elements illustrated in the drawings are not necessary according to scale. Some elements might have been enlarged in order to clearly illustrate those elements.

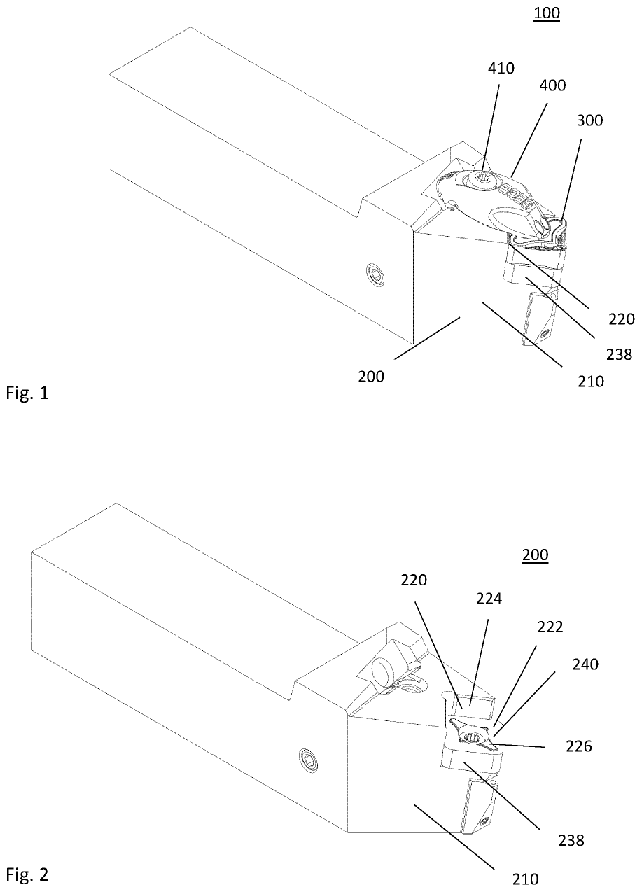

FIG. 1 schematically illustrates a cutting tool (100) according to an embodiment of the invention in form of a turning tool. The cutting tool comprises a toolholder (200) comprising a toolholder body (210) and an insert pocket (220), and a cutting insert (300) mounted in the insert pocket (220). The insert pocket (220) comprises a removable shim (238) arranged between the toolholder body (210) and the cutting insert (300). The cutting insert (300) is secured to the toolholder (200) by use of a fastening clamp (400). The clamp (400) is secured to the toolholder body (210) by use of a fastening screw (410).

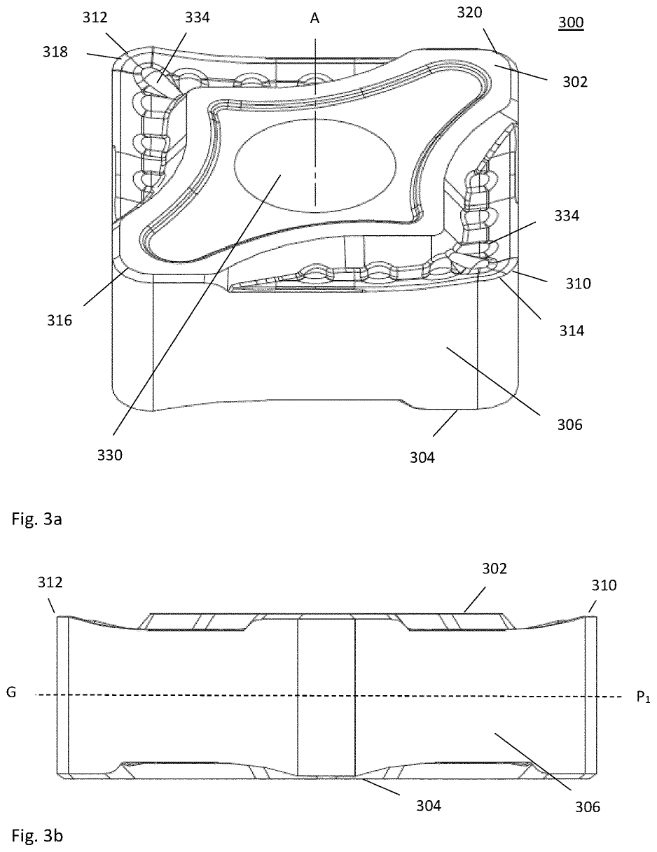

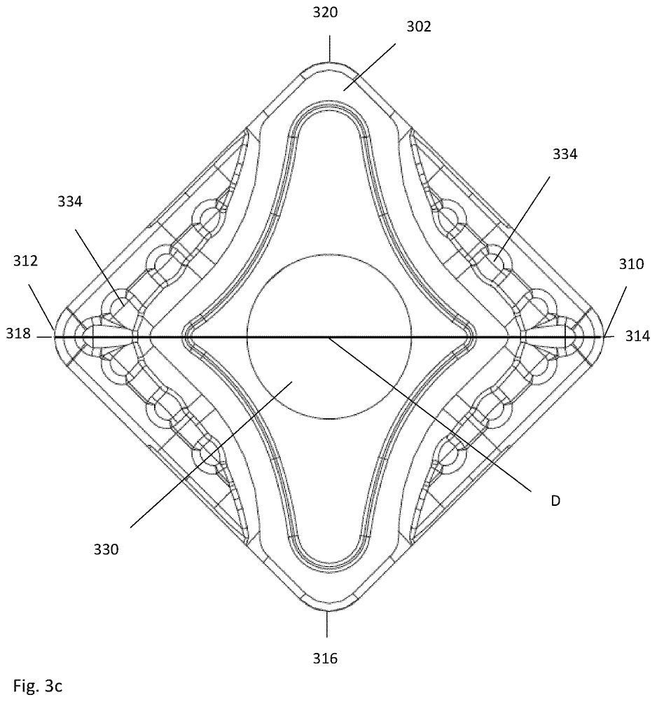

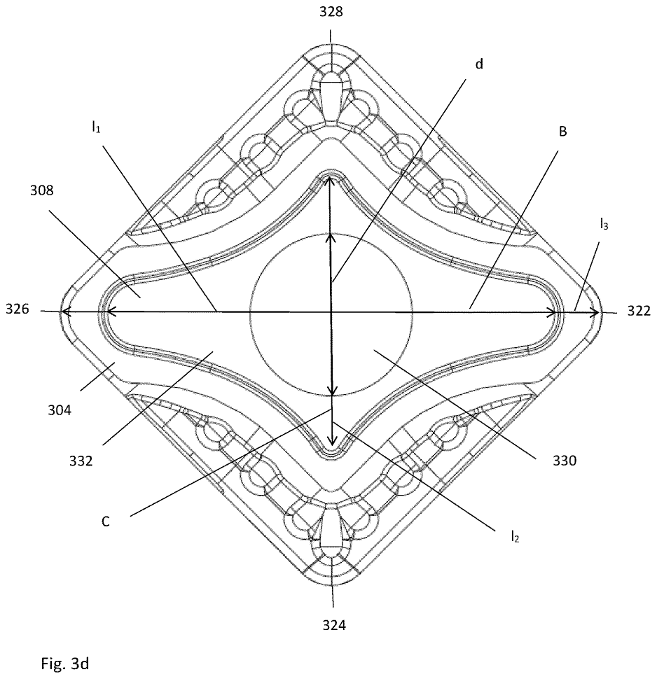

FIG. 2 schematically illustrates the toolholder (200) being part of the cutting tool (100) illustrated in FIG. 1. The insert pocket (220) comprises a bottom support surface (222) and a side support surface (224). The bottom support surface (222) is configured to be in contact with the second main surface (304) of the cutting insert (300), c.f. FIG. 3d. The side support surface (224) is configured to be in contact with the peripheral side surface (306) of the cutting insert (300), c.f. FIG. 3a. The removable shim (238) comprises a top surface (240) which constitutes the bottom support surface (222). The insert pocket (220) comprises a pocket support element (226). The pocket support element (226) is configured to engage with an insert support element (308) in the cutting insert (300), c.f. FIG. 3d.

FIG. 3a schematically illustrates a perspective view of the cutting insert (300) being part of the cutting tool (100) illustrated in FIG. 1. The cutting insert (300) comprises a first square shaped main surface (302), a second square shaped main surface (304), and a peripheral side surface (306) connecting the first main surface (302) and the second main surface (304). The cutting insert (300) has a central axis A extending from the first main surface (302) to the second main surface (304). The first main surface (302) comprises four corners (314,316,318,320). The cutting insert (300) comprises a first cutting edge (310) at a first intersection between the first main surface (302) and the peripheral side surface (306), and a second cutting edge (312) at a second intersection between the first main surface (302) and the peripheral side surface (306), wherein the first cutting edge (310) and the second cutting edge (312) are located at diagonally opposing corners (314,318). The first main surface (302) comprises first and second chip breakers (334) arranged adjacent to the first and second cutting edges (310,312). The cutting insert (300) comprises a through hole (330) extending from the first main surface (302) to the second main surface (304) in the direction of the central axis A.

FIG. 3b schematically illustrates a side view of the cutting insert (300) illustrated in FIG. 3a. The cutting insert (300) comprises a central plane P₁ extending midway between the first main surface (302) and the second main surface (304). The cutting insert (300) is a double sided cutting insert, wherein the central plane P₁ comprises a central axis G extending perpendicular to the central axis A, wherein the at least one cutting insert (300) has a symmetry defined by a rotation of 180° around the central axis G plus a 90° rotation around the central axis A.

FIG. 3c schematically illustrates a top view of the cutting insert (300) illustrated in FIG. 3a. A bisector D bisects the first cutting edge (310) and the second cutting edge (312). The first main surface (302) has an exactly two-fold rotational symmetry around the central axis A.

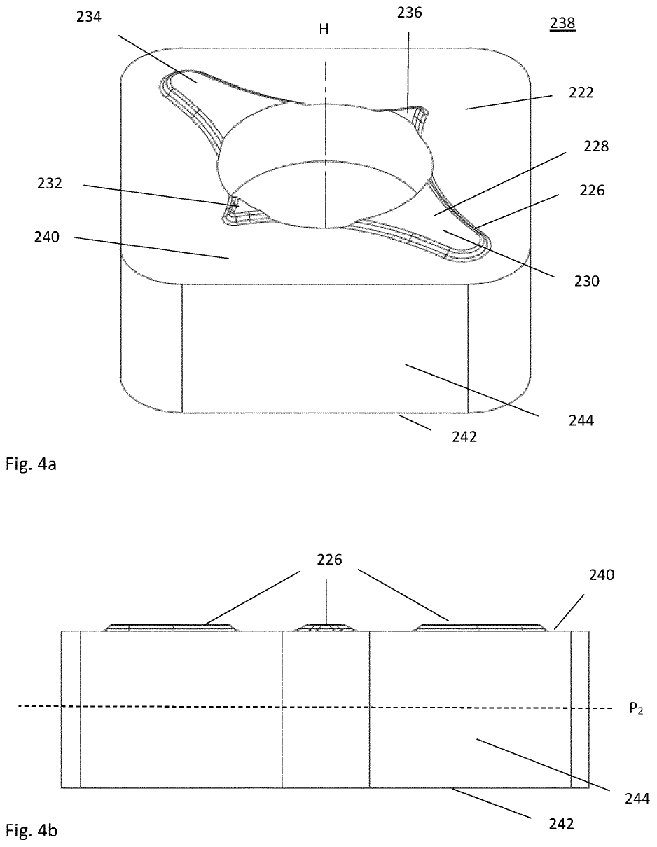

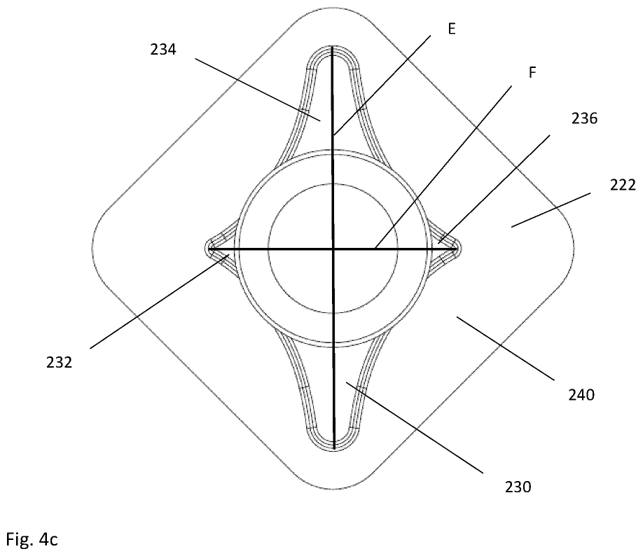

FIG. 3d schematically illustrates a bottom view of the cutting insert (100) illustrated in FIG. 3a. The second main surface (304) has an exactly two-fold rotational symmetry around the central axis A. The cutting insert (300) comprises an insert support element (308) in form of an indention extending from the second main surface (304) towards the central plane P₁. The insert support element (308) is configured to engage with the pocket support element (226) in the bottom support surface (222). The insert support element (308) comprises an insert support surface (332) being parallel to the central plane P₁. The insert support surface (332) is configured to be in contact with a pocket support surface (228) at the pocket support element (226), c.f. FIG. 4a. The insert support element (308) has a major axis B and a minor axis C being perpendicular to each other and to the central axis A, wherein the insert support element (308) has a length l₁ in the direction of the major axis B and a length l₂ in the direction of the minor axis C. The major axis B is parallel to the bisector D. The length l₂ diverges along the direction of the major axis B, wherein l₂ has its maximum at the position l₁/2 along the major axis B. The second main surface (304) comprises four corners (322,324,326,328) and the distance between two diagonally opposing corners (322,326) is l₃. The through hole (330) has a diameter d and intersects the insert support element (308).

FIG. 4a schematically illustrates a perspective view of the removable shim (238) being part of the cutting tool (100) illustrated in FIG. 1. The shim (238) comprises a top surface (240) and a bottom surface (242), and a shim peripheral side surface (244) connecting the top surface (240) and the bottom surface (242). The shim (238) comprises a central axis H extending between the top surface (240) and the bottom surface (242). The top surface (240) constitutes the bottom support surface (222), and the pocket support element (226) is arranged in the top surface (240). The pocket support element (226) is in the form of a protrusion configured to engage with the insert support element (308). The pocket support element (226) comprises a pocket support surface (228) being parallel to the central plane P₁, which is configured to be in contact with the insert support surface (332), c.f. FIG. 3d. The insert support surface (332) is configured to contact the pocket support surface (228) in four contact regions (230,232,234,236), wherein each contact region (230,232,234,236) is separated from the other three contact regions. The four contact regions (230,232,234,236) comprise two major contact regions (230,234) and two minor contact regions (232,236), wherein each major contact region (230,234) has a surface area A₁ and each minor contact region (232,236) has a surface area A₂, wherein A₁>A₂. The major contact regions (230,234) and the minor contact regions (232,236) are alternately arranged in a circumferential direction around the central axis A.

FIG. 4b schematically illustrates a side view of the removable shim (238) illustrated in FIG. 4a. The shim (238) comprises a central plane P₂ extending midway between the top surface (240) and the bottom surface (242).

FIG. 4c schematically illustrates a top view of the removable shim (238) illustrated in FIG. 4a. A bisector E bisects the two major contact regions (230,234) and a bisector F bisects the two minor contact regions (232,236), wherein the bisector E is perpendicular to the bisector F. The bisector E is parallel with the bisector D.

1. A cutting tool comprising:
a toolholder including a toolholder body and at least one insert pocket; and
at least one cutting insert, wherein the at least one cutting insert is mounted within the at least one insert pocket, wherein said at least one cutting insert comprises:
a first square shaped main surface;
a second square shaped main surface; and
a peripheral side surface connecting the first main surface and the second main surface, wherein
the at least one cutting insert includes a central plane extending midway between the first main surface and the second main surface, wherein
the at least one cutting insert includes a central axis extending between the first main surface and the second main surface perpendicular to the central plane, and wherein
the at least one cutting insert includes at least one insert support element, the insert support element being any of:
an indention extending from the second main surface towards the central plane; or
a protrusion extending from the second main surface away from the central plane, wherein
the second main surface has an exactly two-fold rotational symmetry around the central axis, and wherein
the first main surface has an exactly two-fold rotational symmetry around the central axis, wherein
the at least one cutting insert includes a first cutting edge at a first intersection between the first main surface and the peripheral side surface, and a second cutting edge at a second intersection between the first main surface and the peripheral side surface, wherein the first cutting edge and the second cutting edge are separated from each other, wherein
the insert pocket includes a bottom support surface and at least one side support surface, wherein
the bottom support surface is in contact with the second main surface, and wherein the at least one side support surface is in contact with the peripheral side surface, wherein
the insert pocket includes at least one pocket support element, the pocket support element being any of:
a protrusion engaging with the indention in the second main surface, or
an indention engaging with the protrusion at the second main surface, wherein the insert support element includes an insert support surface, and wherein the pocket support element includes a pocket support surface, wherein the insert support surface is in contact with the pocket support surface, and wherein the insert support surface contacts the pocket support surface in a plurality of contact regions, wherein each contact region is separated from the other contact regions.

2. The cutting tool according to claim 1, wherein the first main surface includes four corners and wherein the first cutting edge and the second cutting edge are located at diagonally opposing corners of the first main surface.

3. The cutting tool according to claim 1, wherein the at least one insert support element has a major axis and a minor axis being perpendicular to each other and to the central axis, wherein the at least one insert support element has a length l₁ in the direction of the major axis and a length l₂ in the direction of the minor axis, wherein l₁>l₂.

4. The cutting tool according to claim 3, wherein a bisector bisects the first cutting edge and the second cutting edge, wherein the bisector is parallel to the major axis.

5. The cutting tool according to claim 3, wherein the length l₂ diverges along the direction of the major axis, and wherein l₂ has its maximum at the position l₁/2 along the major axis.

6. The cutting tool according to claim 3, wherein the second main surface includes four corners and wherein a distance between two diagonally opposing corners is l₃, and wherein l₁/l₃≥0.8.

7. The cutting tool according to claim 3, wherein the at least one cutting insert includes a through hole extending from the first main surface to the second main surface (304) in the direction of the central axis, wherein the through hole intersects the insert support element, and wherein the through hole has a diameter d, wherein the maximum value of l₂ is larger than d.

8. The cutting tool according to claim 1, wherein the insert support surface and the pocket support surface are parallel to the central plane.

9. The cutting tool according to claim 1, wherein the insert support surface contacts the pocket support surface in at least four contact regions.

10. The cutting tool according to claim 9, wherein the at least four contact regions include at least two major contact regions and at least two minor contact regions, wherein each major contact region has a surface area A₁ and each minor contact region has a surface area A₂, and wherein A₁>A₂.

11. The cutting tool according to claim 10, wherein the major contact regions and the minor contact regions are alternately arranged in a circumferential direction around the central axis.

12. The cutting tool according to claim 11, wherein a bisector E bisects the two major contact regions and wherein a bisector F bisects the two minor contact regions, wherein the bisector E is perpendicular to the bisector F.

13. The cutting tool according to claim 1, wherein the at least one cutting insert is a double sided cutting insert, wherein the central plane includes a central axis extending perpendicular to the central axis of the at least one cutting insert, and wherein the at least one cutting insert has a symmetry defined by a rotation of 180° around the central axis of the central plane plus a 90° rotation around the central axis of the at least one cutting insert.

14. The cutting tool according to claim 1, wherein the insert pocket includes a removable shim arranged between the toolholder body and the cutting insert, wherein the shim includes a top surface and a bottom surface, and a shim peripheral side surface connecting the top surface and the bottom surface, wherein the shim includes a central plane extending midway between the top surface and the bottom surface, wherein the shim includes a central axis extending between the top surface and the bottom surface perpendicular to the central plane of the shim, wherein the central axis of the shim is arranged coaxially with the central axis of the at least one cutting insert, wherein the top surface constitutes the bottom support surface, and wherein the pocket support element is arranged in the top surface.

15. The cutting tool according to claim 14, wherein the bottom surface includes at least one shim support element, wherein the shim support element is any of:
an indention extending from the bottom surface towards the central plane of the shim; or
a protrusion extending from the bottom surface away from the central plane of the shim, and wherein
the toolholder body includes at least one body support element, the at least one body support element being any of:
a protrusion engaging with the indention in the bottom surface; or
an indention engaging with the protrusion at the bottom surface.
